(19) United States
(12) Patent Application Publication
(10) Pub. No.: US 2011/0033326 A1
(43) Pub. Date: Feb. 10, 2011

(54) SCROLL COMPRESSOR WITH RADIALLY CONFIGURED MOTOR WINDING

(75) Inventors: Dick Cao, Suzhou Industrial Park (CN); Vincent P. Fargo, St. Charles, MO (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Emerson Electric Co., St. Louis, MO (US)

(21) Appl. No.: 12/830,752

(22) Filed: Jul. 6, 2010

Related U.S. Application Data
(60) Provisional application No. 61/231,710, filed on Aug. 6, 2009.

(51) Int. Cl. H02K 23/36; F04C 18/00

(52) U.S. Cl. 418/55.1; 310/198

(57) ABSTRACT

A scroll compressor is more economically constructed and operated. The scroll compressor includes an orbiting scroll member, a non-orbiting scroll member, and a single phase electric motor, the single phase electric motor further includes a rotor, a stator having a plurality of slots, the stator being mounted concentrically with the rotor, an aluminum start winding that is wound within a portion of the slots distal from the rotor, a copper main winding that is wound with a portion of the slots between the aluminum start winding and the rotor, and a drive shaft coupled to the rotor, the drive shaft being configured to couple to the orbiting scroll member of a scroll compressor to cause the orbiting scroll member to orbit the non-orbiting scroll member.

### TECHNICAL FIELD

The invention generally relates to scroll compressors and, more particularly, to electrical motors used to operate scroll compressors.

### BACKGROUND

Refrigeration and air conditioning systems generally include a compressor, a condenser, an expansion valve or its equivalent, and an evaporator. These components are coupled in sequence to define a continuous flow path. A working fluid typically called a refrigerant flows through the system and alternates between a liquid phase and a vapor or gaseous phase. A variety of compressor types have been used to implement refrigeration systems, including, but not limited to, reciprocating compressors, screw compressors, and rotary compressors, such as vane type compressors, for example.

Scroll compressors are becoming more and more popular as the compressor of choice in both refrigeration and air conditioning applications. Scroll compressors are typically constructed using two scroll members with each scroll member having an end plate and a spiral wrap extending from the end plate. The spiral wraps are arranged in an opposing manner with the two spiral wraps being inter-fitted. The scroll members are mounted so that they may engage in relative orbiting motion with respect to each other. During this orbiting movement, the spiral wraps define a successive series of enclosed spaces, each of which progressively decreases in size as it moves inwardly from a radially outer position at a relatively low suction pressure to a central position at a relatively high discharge pressure. The compressed gas exits from the enclosed space at the central position through a discharge passage formed through the end plates of one of the scroll members.

An electric motor or another power source drives one of the scroll members via a suitable drive shaft affixed to the motor rotor. In a hermetic compressor, the bottom of the hermetic shell normally contains an oil sump for lubricating and cooling the various components of the compressor. Relative rotation between the two scroll members is typically controlled by an anti-rotation mechanism. One of the more popular anti-rotation mechanisms is an Oldham coupling, which is keyed to either the two scroll members or to one of the scroll members and a stationary component such as a bearing housing. While Oldham couplings are a popular choice, other anti-rotation mechanisms may also be utilized.

Due to the increasing popularity of scroll compressors, the continued development of these compressors has been directed towards designs that reduce size, reduce complexity and reduce cost without adversely affecting the performance of the scroll compressor. For example, U.S. Pat. No. 7,082,786 incorporates aluminum windings in the electric motor for a scroll compressor that uses ammonia group refrigerants. While the weight and cost of the motor are reduced by using aluminum windings instead of copper windings, more heat is generated by aluminum windings. Consequently, a portion of the discharged refrigerant is diverted to the motor to cool the aluminum windings. Additionally, the motor in this scroll compressor does not obtain the electrical efficiencies made possible by the use of copper windings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### SUMMARY

A single phase electric motor has been configured to reduce weight and cost of a scroll compressor. The electric motor includes a rotor, a stator having a plurality of slots, the stator being mounted concentrically with the rotor, an aluminum start winding that is wound within a portion of the slots distal from the rotor, a copper main winding that is wound with a portion of the slots between the aluminum start winding and the rotor, and a drive shaft coupled to the rotor, the drive shaft being configured to couple to an orbiting scroll member of a scroll compressor.

The single phase electric motor is used in a scroll compressor to enable more economical construction and operation of the scroll compressor. The scroll compressor includes an orbiting scroll member, a non-orbiting scroll member, and a single phase electric motor, the single phase electric motor further includes a rotor, a stator having a plurality of slots, the stator being mounted concentrically with the rotor, an aluminum start winding that is wound within a portion of the slots distal from the rotor, a copper main winding that is wound with a portion of the slots between the aluminum start winding and the rotor, and a drive shaft coupled to the rotor, the drive shaft being configured to couple to the orbiting scroll member of a scroll compressor to cause the orbiting scroll member to orbit the non-orbiting scroll member.

The above and other objects, features and advantages will become apparent to those skilled in the art from the following description.

### BRIEF DESCRIPTION OF THE DRAWINGS

FIG. 1 is a sectional view of a scroll compressor.

FIG. 2 is a sectional view of a stator and a rotor in a motor that depicts a configuration for windings in a stator that may be used in the scroll compressor of FIG.

FIG. 3 is a sectional view of a stator and a rotor in a motor that depicts an alternative configuration for windings in a stator that may be used in the scroll compressor of FIG. 1.

### DESCRIPTION OF THE PREFERRED EMBODIMENTS

The following description of the preferred embodiments is merely exemplary in nature and is no way intended to limit the invention, its application or uses.

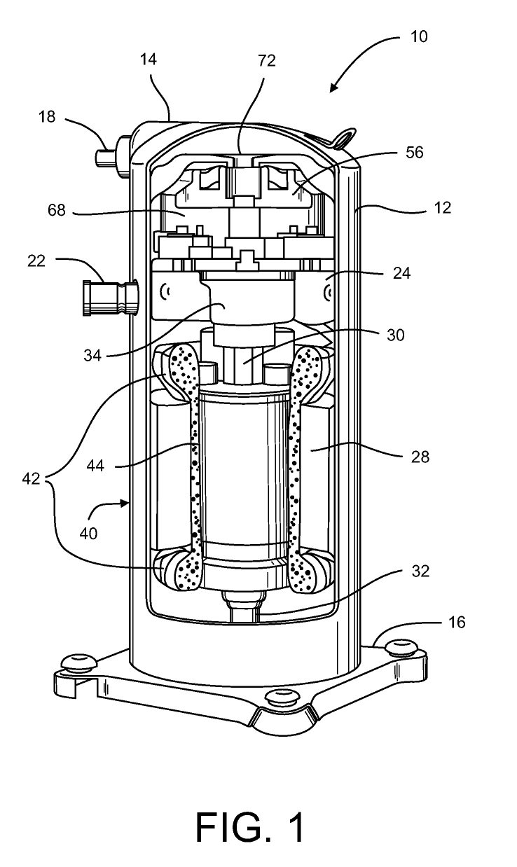

Referring now to the drawings in which like reference numerals designate like or corresponding parts throughout the several views, there is shown in FIG. 1 a scroll compressor, which is designated generally by the reference numeral 10. Scroll compressor 10 comprises a general cylindrical hermetic shell 12 having an upper end cap 14 and a lower end base 16. Cap 14 is provided with a refrigerant discharge fitting 18, which may have the usual discharge valve therein (not shown). Other major elements affixed to shell 12 include an inlet fitting 22, a main bearing housing 24 that is suitably secured to shell 12, and a motor stator 28.

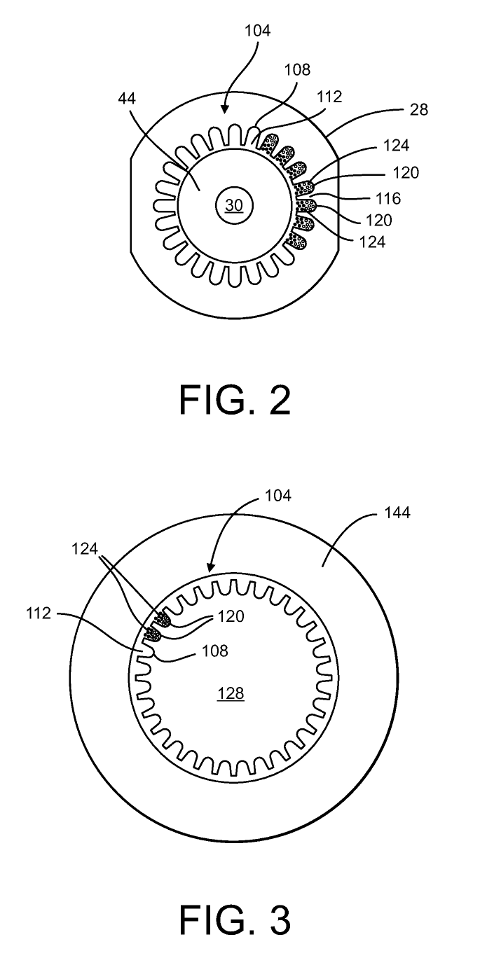

A drive shaft 30 is rotatably journaled in a bearing 34 in main bearing housing 24. Drive shaft 30 has a lower end 32 that is rotatably journaled in the base 16 to enable rotation of the drive shaft 30. Drive shaft 30 extends through a central portion of an orbiting scroll member 56 and the drive shaft is configured at its upper end to couple to the orbiting scroll member 56. The drive shaft 30 is driven by an electric motor 40 that includes motor stator 28 having windings 42 that are wound through slots (FIG. 2) in stator 28. A rotor 44 is press fitted onto drive shaft 30. Coupling the windings 42 in the stator 28 to a single phase power source imparts rotational movement to the rotor 44. The rotation of the rotor 44 rotates drive shaft 30, which drives the orbiting scroll member 56. The orbiting movement of orbiting scroll member 56 with respect to non-orbiting scroll member 68 forms moving pockets for fluid and the volume of the fluid in the pockets is reduced as the pockets travel from a radially outer position to a central position of scroll members 56 and 68. Orbiting scroll member 56 has a radially inwardly disposed discharge port, which is in fluid communication with a discharge chamber 72 defined by cap 14 and shell 12. Fluid compressed by the moving pockets between scroll members 56 and 68 discharges into discharge chamber 72.

To reduce the cost of the windings 42 as well as the weight of the motor 40, a portion of the windings 42 may be implemented with aluminum windings and the remainder of the windings may be implemented with copper windings. Preferably, a start winding is constructed with aluminum wire while a main winding of the motor 40 is constructed with copper wire. Current is supplied to the start winding to commence rotation of the motor 40. This structure provides a number of benefits for the scroll compressor. For one, the aluminum winding is relatively cheaper and lighter in weight than the copper winding. Although aluminum wire generates more heat than copper wiring, the use of the aluminum winding only during the starting of the motor reduces the amount of time that the aluminum winding is generating heat because it is being supplied with current.

To further enhance the transfer of electrical fields from the copper main winding to the rotor, the main copper winding and the aluminum start winding are wound within the stator as shown in FIG. 2. As shown in that figure, a partially wound stator 28 is concentrically mounted about the rotor 44. The stator includes a plurality of slots 104. Each slot has a portion 108 that is distal from the rotor 44 and a portion 112 that is near the rotor 44. Copper wires are represented by filled circles in the slots of the stator 28. For example, the copper wires 124 form a winding about tooth 116. Aluminum wires are represented by open circles. In this example, the aluminum wires 120 form a winding about tooth 116. Thus, the aluminum start winding is formed by aluminum wires being wound through the portions of the slots in the stator that are distal from the rotor 44. Likewise, the copper main winding is formed by copper wires being wound through the portions of the slots in the stator that are near the rotor 44. This configuration enables the copper wires to be exposed at the openings of the slots 104 to transfer more efficiently the electrical field from the copper main winding to the rotor 44.

An alternate embodiment is shown in FIG. 3. The embodiment of FIG. 3 is formed by a rotor 144 being concentrically mounted about a stator 128. Again, the stator has a plurality of slots 104 and each slot has a portion 108 that is distal from the rotor 144 and a portion 112 near the rotor 144. Aluminum wires 120, represented by the open circles, are wound through the distal portions 108 of the slots 104, while copper wires 124, represented by filled circles, are wound through the near portions 112 of the slots 104. Current flowing through the start winding and the main coil generates moving magnetic fields that rotate the rotor 144 about the stator 128. The aluminum wires are exposed at the distal portions of the slots to enhance cooling of the aluminum wires by gas flow over the motor 40.

The windings 120 and 124 may be used in the motor 40 of the scroll compressor 10 to reduce the weight and cost of the compressor 10. The arrangement of the aluminum start winding and the copper main winding in the slots of the stator 28 enable the compressor to operate more efficiently and to enhance the cooling of the aluminum start winding after the winding is decoupled from a single phase power source.

Those skilled in the art will recognize that numerous modifications can be made to the specific implementations of the ink umbilical described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed:

1. A single phase electric motor configured for use in a scroll compressor, the electric motor comprising:
a rotor;
a stator having a plurality of slots, the stator being mounted concentrically with the rotor;
an aluminum start winding that is wound within a portion of the slots distal from the rotor;
a copper main winding that is wound with a portion of the slots between the aluminum start winding and the rotor; and
a drive shaft coupled to the rotor, the drive shaft being configured to couple to an orbiting scroll member of a scroll compressor.

2. The electric motor of claim 1, the stator being mounted concentrically within the rotor.

3. The electric motor of claim 1, the rotor being mounted concentrically within the stator.

4. A scroll compressor comprising:
an orbiting scroll member;
a non-orbiting scroll member; and
a single phase electric motor, the single phase electric motor further comprising:
a rotor;
a stator having a plurality of slots, the stator being mounted concentrically with the rotor;
an aluminum start winding that is wound within a portion of the slots distal from the rotor;
a copper main winding that is wound with a portion of the slots between the copper main winding and the rotor; and
a drive shaft coupled to the rotor, the drive shaft being configured to couple to the orbiting scroll member of a scroll compressor to cause the orbiting scroll member to orbit the non-orbiting scroll member.

5. The scroll compressor of claim 4, the stator being mounted concentrically within the rotor.

6. The scroll compressor of claim 4, the rotor being mounted concentrically within the stator.
